(19) United States
(12) Patent Application Publication
(10) Pub. No.: US 2003/0227599 A1
(43) Pub. Date: Dec. 11, 2003

(54) Producing smooth edge transitions in displayed composite images

(76) Inventors: Yizhak Weissman, Tel Aviv (IL); Gideon Pesach, Tel Aviv (IL)

Correspondence Address: Anthony Castorina, G E Ehrlich, Suite 207, 2001 Jefferson Davis Highway, Arlington, VA, 22202, US

(21) Appl. No.: 10/276,998

(22) PCT Filed: May 17, 2001
(86) PCT No.: PCT/IL01/00445

(30) Foreign Application Priority Data
May 21, 2000 (IL) 136263

(51) Int. Cl. G03B 21/26

(52) U.S. Cl. 353/94

(57) ABSTRACT

A method and apparatus for producing smooth light-intensity transitions in overlapping regions of a composite image projected by a plurality of electrically-controlled projectors and displayed on a screen by disposing shadowing devices between each projector and the screen to cast gradual shadow in the overlapping regions to reduce light-intensity variations therein; and electrically controlling the gain of the projectors to substantially eliminate any residual variations in light-intensity in the overlapping regions.

### FIELD AND BACKGROUND OF THE INVENTION

The present invention relates to methods and apparatus for producing smooth edge transitions in displayed composite images. The invention is particularly useful in front-projection systems including curved screens on which multi-colored composite images are displayed, and is therefore described below with respect to such applications.

Display systems based on a single image projector are limited in the number of pixels they can display and in their brightness. In large display systems, therefore, it is generally necessary to combine several image projectors to create a single combined or composite image. In order to create a smooth transition between adjacent images, it is necessary to overlap them at their edges. However, the overlapping regions obtain illumination with double intensity, and therefore it is necessary to attenuate the image at their edges, i.e., to produce “soft edges”, in order to avoid variations in light-intensity in these edges.

Several techniques have been proposed for producing smooth light-intensity transitions in overlapping regions of composite images. One known technique is to apply a spatially variable electronic gain to the image by controlling the gain of the respective projectors, as described, for example, in U.S. Pat. Nos. 4,974,073, 5,136,390 and 6,219,011, and the publication Lyon, Paul “Edge-Blending Multiple Projection Displays On a Dome Surface to Form Continuous Wide Angle Fields-of-View,” pp. 203-207, Proceedings, Nov. 19-21, 1985, 7^{th} Interservice Industry Training Equipment Conference, the disclosures of which are hereby incorporated by reference. This technique is relatively simple when the projector is a cathode ray control tube. However, where the projector is an LCD (liquid crystal display) or DLP (digital light processor), gain control is much less effective since such projectors emit significant light even in their black state; therefore, electronic gain alone can not create soft edges in completely black images since complete black color can not be further darkened by electronic means.

Another known technique is to use appropriate shadowing devices, normally in the form of blades (either opaque or semi-transparent), disposed between the respective projector and the screen to attenuate the overlapping regions in order to reduce light-intensity variations therein. Such devices cast a gradual shadow on the screen, and therefore can be used to create soft edges. However, when using such shadowing devices (e.g., a blade), only the shadow profile width, and not the shadow profile shape, can be controlled by the shadowing geometry. The inability to control the shadow profile shape can cause unwanted intensity variations in the overlapping regions, as will be described more particularly below.

Another drawback of shadowing devices is that a non-smooth intensity distribution in the exit pupil of the projector causes a non-smooth shadow profile, as will also be described more particularly below.

A further drawback in the use of shadowing devices is that variations in intensity in the light exiting from the lens exit pupil of the projector are usually different for the various colors. This creates different shadow profiles for each of the three basic colors, and consequently, the appearance of undesired colors in the overlapping regions.

A still further drawback in the use of shadowing devices is present particularly in front-projector systems which have screens that are curved in order to increase the field of view and also the immersion feeling of the viewer. As will also be described more particularly below, the shadow profiles produced by the conventional blades in such front-projector systems also result in non-uniform intensity of the light in the overlapping regions.

Another drawback in the use of shadowing devices results from a certain optical feature which causes the shadow of a straight blade to appear curved even on a planar screen. This optical feature is present in many types of projection systems. As will also be described more particularly below, the shadow profiles produced by the conventional blades in such front-projector systems also result in non-uniform intensity of the light in the overlapping regions.

### BRIEF SUMMARY OF THE INVENTION

According to one aspect of the present invention, there is provided a method of producing smooth light-intensity transitions in overlapping regions of a composite image projected by a plurality of electrically-controlled projectors and displayed on a screen, comprising: disposing shadowing devices between each projector and the screen to cast gradual shadows in the overlapping regions to reduce light-intensity variations therein; and electrically controlling the gain of the projectors to substantially eliminate any residual variations in light-intensity in the overlapping regions.

According to further features in the described preferred embodiments, the shadow is multi-colored, and the gain of each of the projectors is electrically controlled for each color.

Some or all of the shadowing devices may be blades having sawtooth obscuring edges defined by teeth of a pitch considerably smaller than the diameter of the exit pupil of the respective projector, such as to average out intensity variations that would have appeared in the shadow of a straight blade. On the other hand, some or all of the shadowing devices could be masks having patterns of gradual opacity to smoothen out spatially-fine intensity variations in the shadow.

According to a still further aspect of the invention, at least some of the shadowing devices are blades having curved obscuring edges producing shadow profiles having center lines coinciding with the center lines of the overlapping regions to thereby reduce light-intensity variations in the overlapping regions caused by the curvature of the screen. The need for blade-curving arises from either the screen being curved, or from a certain optical feature in the projection lens which causes curving of the shadow of straight blades even on a planar screen.

The invention also provides apparatus for producing smooth light-intensity transitions in overlapping regions of a composite image in accordance with the foregoing method.

As will be described more particularly below the method and apparatus of the present invention enable smooth light-intensity transitions to be produced in overlapping regions of composite images even with respect to completely black images, and with respect to all colors.

Further features and advantages of the invention will be apparent from the description below.

### BRIEF DESCRIPTION OF THE DRAWINGS

The invention is herein described, by way of example only, with reference to the accompanying drawings, wherein:

FIG. 1 schematically illustrates a prior art projector system including two projectors producing two images having overlapping regions;

FIG. 1a illustrates one case of variation in the light-intensity at the overlapping regions;

FIG. 2 schematically illustrates another prior art projector system including a known gain-control technique for smoothing the light-intensity transitions at the overlapping regions, FIGS. 2a and 2b illustrating how this is done;

FIG. 3 illustrates another prior art projector system for reducing light-intensity transitions at the overlapping regions, FIGS. 3a, 3b and 3c illustrating how this is done;

FIG. 4 illustrates one form of projector system constructed in accordance with the present invention for reducing light-intensity variations in overlapping regions of a composite image, FIG. 4a illustrates the intensity uniformity attainable in the projector system of FIG. 4; and FIG. 4b illustrates how the intensity uniformity is attained;

FIG. 5 illustrates an extreme case of a non-smooth shadow profile (in the form of intensity staircase); and FIG. 5a illustrates one form of shadow-producing blade which may be used in this case to smooth out light-intensity variations in the overlapping regions;

FIG. 6 illustrates a front-projection system including a curved screen constructed in accordance with the invention for reducing light-intensity variations in the overlapping regions;

FIGS. 6a and 6b are diagrams helpful in explaining the manner in which light intensity variations are reduced in the projector system of FIG. 6;

FIG. 7 illustrates one construction of a shadowing device which may be used in the projector system of FIG. 6; and

FIG. 8 illustrates another construction of a shadowing device which may be used in the projector of FIG. 6.

### BRIEF DESCRIPTION OF THE PRIOR ART

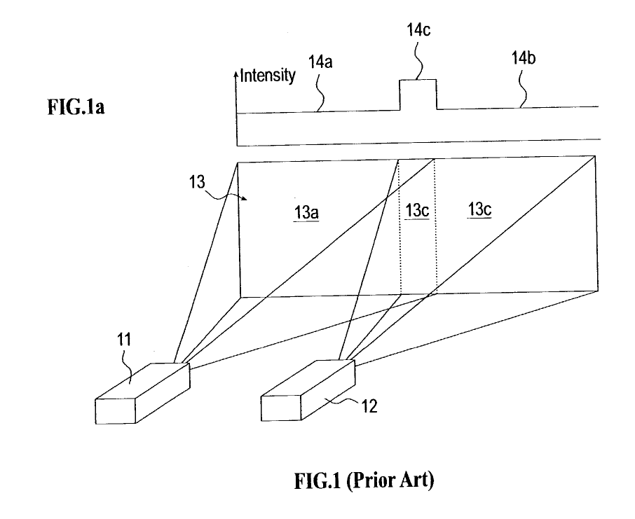

FIG. 1 illustrates a projector system including a plurality of projectors (only two of which are shown at 11 and 12, respectively) for projecting, onto a screen 13, sections of a large image to be combined on the screen. Thus, as shown in FIG. 1, section 13a of the screen 13 receives the portion of the image projected by projector 11; section 13b of the screen receives the portion of the image projected by projector 12; while section 13c of the screen receives the overlapping regions of the two images. Assuming that both projectors 11 and 12 project the respective images with equal intensity, it will be seen that the light-intensity on the screen is uniform for sections 13a and 13b, as shown at 14a, 14b in FIG. 1a; whereas the light-intensity in the overlapping regions 13c is substantially larger, as shown at 14c in FIG. 1a.

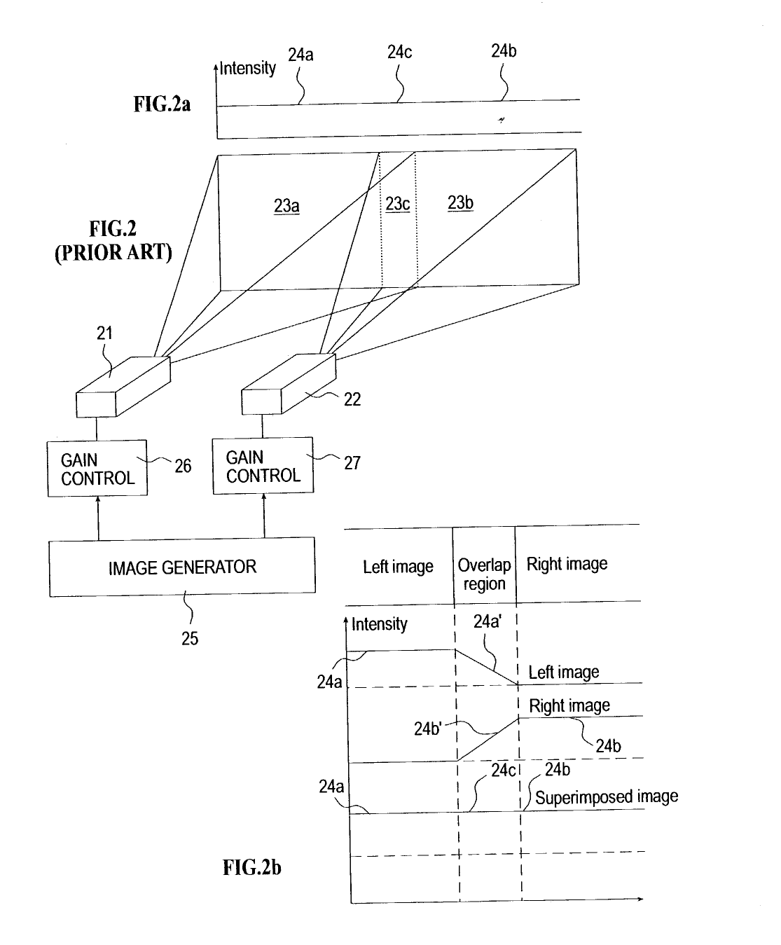

FIG. 2 illustrates a prior art projector system including gain control for reducing the light-intensity variations in the overlapping regions, as described, for example, in the above-cited patents and publication. Thus, FIG. 2 illustrates two projectors 21, 22, for projecting their respective images on screen sections 23a, 23b, respectively, and in the overlapping region 23c, as in FIG. 1. FIG. 2 also illustrates the image generator 25 for generating the images projected by the two projectors 21, 22. In this case, each projector 21, 22 has a gain control, shown at 26, 27, respectively, to control the image projected by the respective projector in the overlapping region 23c, so as to reduce or eliminate the light-intensity variations in the overlapping region, such that the light intensity 24a, 24b, 24c, in the three regions 23a, 23b, 23c is substantially uniform, as shown in FIG. 2a.

FIG. 2b illustrates the light-intensity profile produced by each projector in such a projector system. Thus, the light-intensity produced by projector 21 on screen section 23a is shown at 24a, the light-intensity produced by projector 22 on screen 23b is shown at 24b, and the light-intensity produced in the overlapping region 23c by the two projectors is shown at 24a′ and 24b′, respectively, in FIG. 2b, to produce in region 24c a light-intensity 24 which is substantially equal to that in regions 24a, 24b. However, as indicated earlier, while this technique is reasonably effective with cathode ray tube projectors which can be completely darkened so as to produce no light, it is not as effective with respect to LCD (liquid crystal display) or DLP (digital light processing) projectors which emit significant light even in their black state, so that electronic gain alone can not create the required “soft edge” in completely black images.

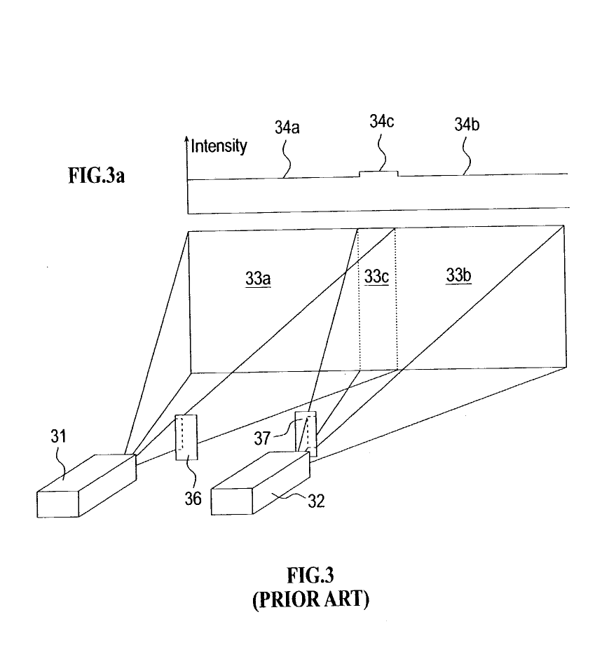

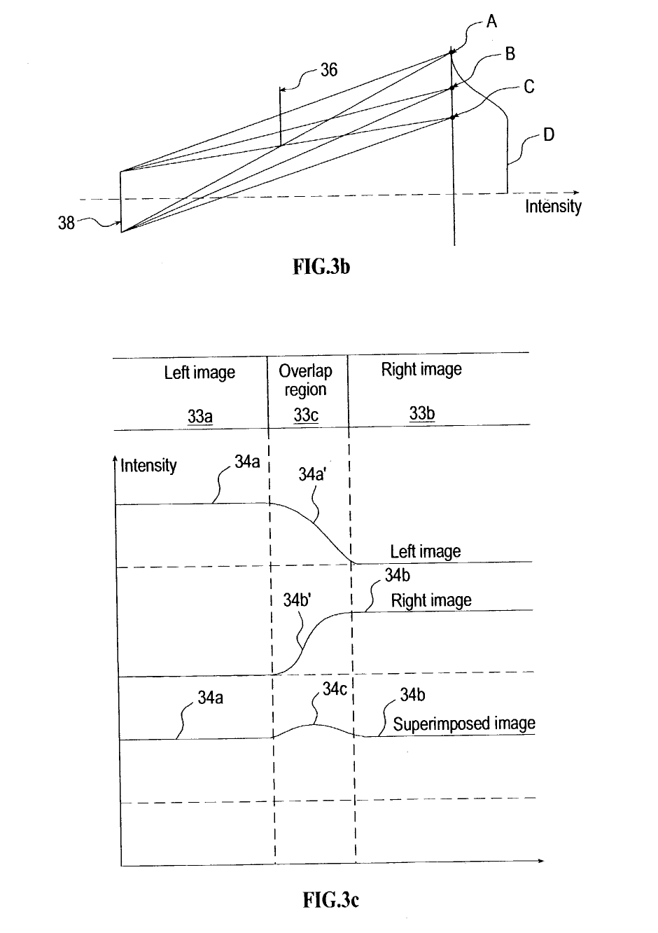

FIG. 3 illustrates another prior art projector system wherein the projectors 31, 32, projecting their respective images on section 33a, 33b of the screen and in the overlapping region 33c, are provided with shadowing blades 36, 37 between each projector and the screen to attenuate the overlapping regions in section 33c of the screen, in order to reduce light-intensity variations therein. FIG. 3b illustrates one such shadowing device 36 (for projector 31, FIG. 3) located with respect to the lens exit pupil 38 of the respective projector 31, such that point A is 100% obscured, point B is 50% obscured, and point C is 0% obscured, to produce the intensity profile D illustrated in FIG. 3b. FIG. 3c illustrates the intensity produced by each of the projectors 31, 32, namely the uniform intensity 34a produced by projector 31 in its screen section 33a, the uniform intensity 34b produced by projector 32 in its screen section 33b, and the varying intensities 34a′ and 34b′ produced by the two projectors in the overlapping region 33c, resulting in the light-intensity profile 34c in this overlapping region.

It is to be noted, however, that in general it is not possible to eliminate completely intensity variations in the overlap region with shadowing devices only. FIGS. 3a and 3c show a particular example of fluctuation in the light-intensity 34c in the overlapping region 33c in the form of a “hump”.

### DESCRIPTION OF PREFERRED EMBODIMENTS OF THE INVENTION

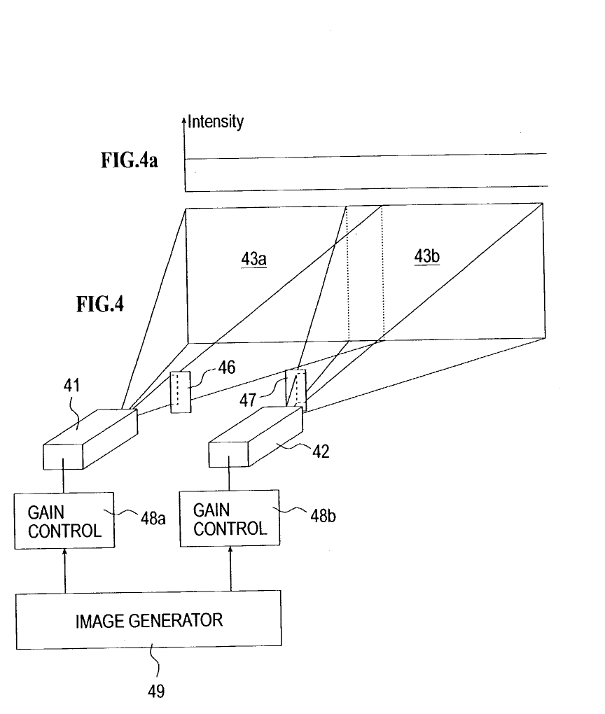

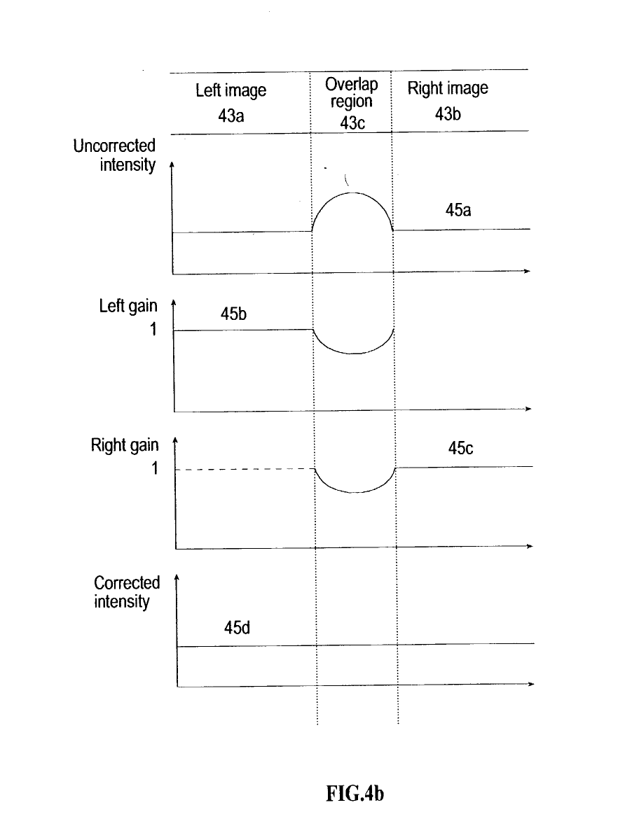

FIGS. 4-8 illustrate several preferred embodiments of projector systems constructed in accordance with the present invention.

The projector systems described below include a plurality of electrically-controlled projectors which produce smooth light-intensity transitions in the overlapping regions of the composite image by disposing shadowing devices between each projector and the screen to cast gradual shadows in the overlapping regions to reduce light-intensity variations therein, while the gains of the projectors are electrically controlled to substantially eliminate any residual variations in light-intensity in the overlapping regions. The shadow is multi-colored, and the gain of each of the projectors is electrically controlled for each color. Preferably, the shadowing devices are opaque blades, which protrude into the edge of the beam of the projector, but they could also be masks disposed on transparent windows which cast a gradual shadow on one or more edges of the image.

When using a blade as a shadowing device, the shadow profile can be further controlled by modifying its edge to a sawtooth or similar shape. This modifies the shadow profile, increasing its width, among other features. The use of a sawtooth blade serves also to smooth out spatially-fine intensity variations in the shadow.

A strip of opaque material deposited on a transparent window behaves optically also as a blade. An optical window with a semi-transparent pattern is generally called a mask. Using a mask gives more options than using a blade; in particular, it is possible to make patterns with a gradual opacity. This mimics a sawtooth blade, but has superior optical performance. Masks are much more expensive than blades, and, therefore, blades are preferred whenever possible.

FIG. 4 illustrates a projector system including, for purposes of simplifying the description, two projectors 41, 42 projecting their respective images on screen sections 43a, 43b, and in the overlapping section 43c. In this case, a shadowing device 46, 47, e.g. a blade or mask, is disposed between each projector 41, 42, and the screen to attenuate the light in the overlapping regions and thereby to reduce the light-intensity variations therein, as described above with respect to FIG. 3. However, the projector system illustrated in FIG. 4, is further provided with a gain control 48a, 48b, between the image generator 49 and the respective projectors 41, 42, to substantially eliminate the “hump” (34c, FIGS. 3a and 3c) in the conventional projector system of FIG. 3, as shown in FIG. 4a. In case that the intensity fluctuations are different for each color, the gain of each projector is electrically-controlled for each color separately.

FIG. 4b illustrates how the residual irregularities that remain after the application of the shadowing devices are eliminated by using appropriate electronic gain control on the corresponding edges of the overlapping images. Curve 45a represents a non-uniform intensity distribution exhibiting a “hump” (the same as 34c in FIG. 3c). By electronically attenuating the light at the edges as shown by the gain curves 45b and 45c, the hump is eliminated, resulting in a uniform intensity distribution 45d.

Electronic attenuation of light in the image is accomplished by multiplying its RGB pixel values by a special image called “gain pattern”. The multiplication is done pixel by pixel, and for each color separately. The pixel values of the gain pattern take values between 0 and 1, so that the RGB pixel values of the attenuated image are never bigger than the original ones. The gain pattern for soft edge blending will normally have pixel values less than 1 only in the overlap region.

The following is to be noted regarding this technique:

(1) This technique can be used only to attenuate light, and not to amplify it. This means that in order to apply this method, there must be more light in the overlap region than desired. This situation can be always achieved by reducing the protrusion of the shadowing devices' blades or masks into the corresponding beams.

(2) The effect of this method diminishes as the images turn darker, and vanishes in a completely dark image.

(3) The intensity variations can be different in each one of the three colors. This requires separate gain control in each color.

The overlap region has generally the form of an elongated shape, like a rectangle, with one dimension much larger than the other. In general, intensity variations in this shape can have a random and irregular pattern. Correction of such variations with the gain method requires a very elaborate correction process. A major design goal in the shadowing devices is to make the intensity fluctuations invariant with respect to the longer dimension. This simplifies significantly the gain pattern that is needed to correct such fluctuations, and, consequently, the correction process.

Another design goal is to smooth out spatially-fine intensity fluctuations, in order to reduce the complexity of the gain correction. For example, such intensity fluctuations are caused in LCD projectors by lenslet arrays that are introduced in the illumination path.

The shadow should affect only the overlap region. Therefore, the width of the shadow profile must be smaller than the width of the overlap region. In case that the shadowing device is a blade, its shadow profile width can be controlled by changing its distance to the projector lens: increasing this distance decreases the width (reducing it to zero when the shadowing device is in contact with the screen).

The system illustrated in FIG. 4 is thus capable of substantially eliminating variations in light-intensity in the overlapping region 43c also with the modern type projectors (LCD, DLP) which emit significant light even in their black state, and for all colors.

In some cases, abrupt or fine intensity fluctuations may appear in the shadow profile. This may be due, for example, to the use of a lenslet array in the illumination optics, commonly utilized in LCD projectors. An extreme (and artificial) case of abrupt intensity fluctuations in shadow are shown, for the sake of illustration, in FIG. 5. The intensity decrease curves 55a and 55b have the shape of abrupt stairs rather than smooth curves. The superimposed shadow 55c exhibits fine and abrupt intensity fluctuations. The corrections of such intensity fluctuations require a very elaborate tuning process.

FIG. 5a illustrates a preferred construction of shadowing blade which may be used in order to substantially smooth out fine irregularities in light-intensity in the overlapping region due to a non-smooth shade profile, as described above with respect to FIG. 5. Thus, as shown in FIG. 5a, the obscuring edge of the shadowing blade 50 is of a sawtooth configuration, as shown at 51, having teeth of a pitch considerably smaller than the diameter of the projector lens exit pupil. In such an arrangement, the obscuring edge tends to blur or average out intensity variations caused by the non-smooth shade profile described above with respect to FIG. 5. Thus, making the teeth pitch much smaller than the exit pupil diameter better assures that the teeth also become blurred when the blade-lens distance is much smaller than the blade-screen distance.

FIG. 5a illustrates an example of such a blade construction in the case of a projector system wherein the lens exit pupil of the respective projector is 10 mm, the distance of the blade to the exit pupil is 20 cm, and the projection distance is 4 M. In the illustrated construction, the length of the blade is 20 cm; the height of each tooth is 2 mm; and the pitch between teeth is 1 mm.

Such design is limited to cases in which the pitch is much larger than the blade thickness. If this condition is not satisified, light rays in the corners of the image will “see” a different sawteeth profile compared to the edge center. This can cause non-uniform light intensity distribution along the longer dimension of the overlap region, which is undesirable. In this case, it is preferable to use a mask with gradual attenuation at the edge.

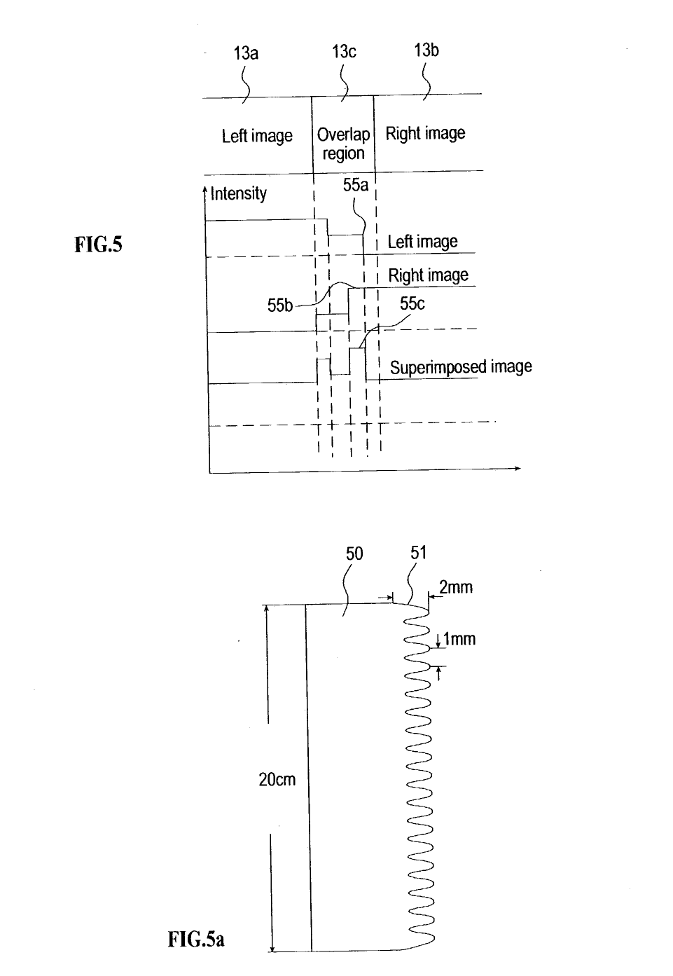

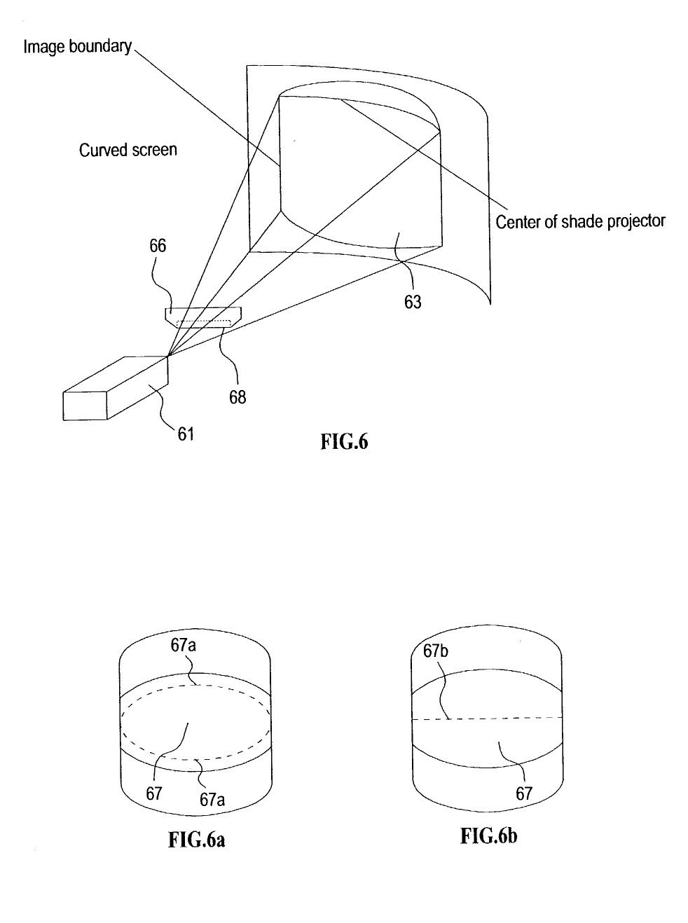

FIG. 6 illustrates a front projector system constructed in accordance with the present invention including a curved screen. Such systems increase the field of view for the same image area and also increase the immersion feeling of the viewer with respect to the displayed image. While FIG. 6 illustrates only a single projector 61 and a single screen section 63, it will be appreciated that the projector system would include a plurality of such projectors and a screen sufficiently large to combine the images of all the projectors into a single combined image.

Each projector is provided with a shadowing device, e.g., a blade or mask, shown at 66 in FIG. 6, between the respective projector and the screen. When the blade has a straight obscuring edge, the shadow produced would have a curvature because of the curved screen. Such a curvature is shown in FIG. 6a by the curved broken lines 67a representing the center line of the shadow. This figure illustrates two images stacked vertically on a cylidrical screen. In this case, since the center lines 67a of the two produced shadows are curved in the overlapping region 67, the light-intensity in the overlapping region would not be uniform with respect to its longer dimension, but rather would be more intense in the center between the two curved shadow center lines 67a.

In order to eliminate the variations in light-intensity along the longer dimension of the overlapping region, the shadowing blades 66 are provided with curved obscuring edges, as shown at 68 in FIG. 6. FIG. 6b illustrates the shadow produced by such a curved blades in two vertically stacked projectors. The center lines 67b of the respective shadows coincide with the center line of the overlapping region 67, thereby producing a uniform light-intensity with respect to the longer dimension of the overlapping region.

Shadow curvature can be caused also by a certain optical feature common to many projection systems (“optical shadow curving”). Without going into a detailed explanation of this effect, it is to be noted that it is handled in exactly the same manner as shadow curving caused by a curved screen, i.e., by incorporating a suitable curvature in the blade profile, as explained above.

Optical shadow curving may be present in projecting on a curved screen. In this case, the curvatures introduced by both effects have to be combined to properly correct the shadow profile.

FIG. 7 illustrates an example of the construction of a shadowing device which may provided for each projector between its lens exit pupil and the screen. Such a construction includes a housing 70 of rectangular configuration formed with shadowing blades 71, 72 and 73 at each side producing a shadow to overlap with a shadow in the next adjacent projector. Each shadow blade 71-73 would be provided with a curved obscuring edge 71a-73a, respectively, as described above with respect to FIG. 6.

As further shown in FIG. 7, each of the shadowing blades 71-73 is carried by a mounting plate 74 adjustably mounted by screw 75 to permit precise adjustment of the obscuring edge of the respective shadowing blade.

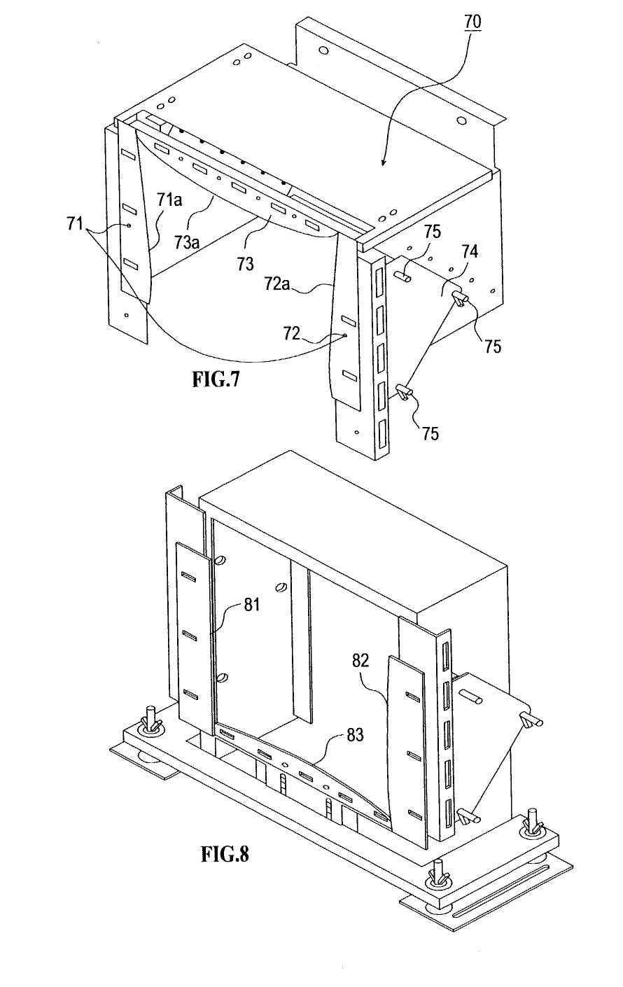

In the shadowing device of FIG. 7, the shadowing blades 71-73 are mounted in the two vertical sides of the device and the upper side. FIG. 8 illustrates a similar construction wherein shadowing blades 81-83, as described above, are mounted in the two vertical sides and the lower side of the housing 80. In both constructions, the shadowing device could also be masks, as described above.

While the invention has been described with respect to several preferred embodiments, it will be appreciated that these are set forth merely for purposes of example, and that many other variations, modifications and applications of the invention may be made.

What is claimed is:

1. A method of producing smooth light-intensity transitions in overlapping regions of a composite image projected by a plurality of electrically-controlled projectors and displayed on a screen, comprising:
disposing shadowing devices between each projector and the screen to cast gradual shadows in said overlapping regions to reduce light-intensity variations therein;
and electrically controlling the gain of said projectors to substantially eliminate any residual variations in light-intensity in said overlapping regions.

2. The method according to claim 1, wherein said shadow is multi-colored, and the gain of each of said projectors is electrically controlled for each color.

3. The method according to claim 1, wherein at least some of said shadowing devices are blades having sawtooth obscuring edges defined by teeth of a pitch considerably smaller than the diameter of the exit pupil of the respective projector, such as to average out intensity variations that would have appeared in the shadow of a straight blade.

4. The method according to claim 1, wherein the screen is curved, the projectors are located in front of the screen, and at least some of said shadowing devices are blades having curved obscuring edges producing shadow profiles having center lines coinciding with the center lines of the overlapping regions to thereby reduce light-intensity variations in the overlapping regions caused by the curvature of the screen.

5. The method, according to claim 1, wherein said shadowing devices are masks, having patterns of gradual opacity to smoothen out spatially-fine intensity variations in the shadow.

6. The method, according to claim 1, wherein the gain of each projector is controlled by multiplying each pixel value in said overlapping region by a gain pattern value of between “0” and “1”.

7. A method of producing smooth light-intensity transitions in overlapping regions of a composite image projected by a plurality of electrically-controlled projectors and displayed on a screen, comprising:
disposing shadowing devices between each projector and the screen to cast gradual shadows in said overlapping regions to reduce light-intensity variations therein;
at least some of said shadowing devices being blades having sawtooth obscuring edges defined by teeth of a pitch considerably smaller than the diameter of the exit pupil of the respective projector, such as to average out intensity variations that would have appeared in the shadow of a straight blade.

8. The method according to claim 7, further comprising:
electrically controlling the gain of said projectors to substantially eliminate any residual variations in light-intensity in said overlapping regions.

9. The method according to claim 8, wherein said shadow is multi-colored, and the gain of each of said projectors is electrically controlled for each color.

10. The method according to claim 7, wherein the screen is curved, the projectors are located in front of the screen, and at least some of said shadowing devices are blades having curved obscuring edges producing shadow profiles having center lines coinciding with the center lines of the overlapping regions to thereby reduce light-intensity variations in the overlapping regions caused by the curvature of the screen.

11. Apparatus for producing smooth light-intensity transitions in overlapping regions of a composite image, comprising:
a plurality of electrically-controlled projectors for projecting said composite image;
a screen for displaying said composite image as projected by said projectors;
and a shadowing device between each projector and the screen for attenuating said overlapping regions to reduce light-intensity variations therein;
said electrically-controlled projectors including a gain control and means for controlling the gain to substantially eliminate any residual variations in light-intensity in said overlapping regions.

12. The apparatus according to claim 11, wherein said shadow is multi-colored, and the gain of each of said projectors is electrically controlled for each color.

13. The apparatus according to claim 11, wherein at least some of said shadowing devices are blades having sawtooth obscuring edges defined by teeth of a pitch considerably smaller than the diameter of the exit pupil of the respective projector, such as to average out intensity variations that would have appeared in the shadow of a straight blade.

14. The apparatus according to claim 11, wherein the screen is curved, the projectors are located in front of the screen, and at least some of said shadowing devices are blades having curved obscuring edges producing shadow profiles having center lines coinciding with the center lines of the overlapping regions to thereby reduce light-intensity variations in the overlapping regions caused by the curvature of the screen.

15. The apparatus, according to claim 11, wherein said shadowing devices are masks, having patterns of gradual opacity to smoothen out spatially-fine intensity variations in the shadow.

16. The apparatus, according to claim 11, wherein the gain of each projector is controlled by multiplying each pixel value in said overlapping region by a gain pattern value of between “0” and “1”.

17. Apparatus for producing smooth light-intensity transitions in overlapping regions of a composite image, comprising:
a plurality of electrically-controlled projectors for projecting said composite image;
a screen for displaying said composite image as projected by said projectors;
and a shadowing device between each projector and the screen for attenuating said overlapping regions to reduce light-intensity variations therein;
at least some of said shadowing devices being blades having sawtooth obscuring edges defined by teeth of a pitch considerably smaller than the diameter of the exit pupil of the respective projector, such as to average out intensity of variations that would have appeared in the shadow of a straight blade.

18. The apparatus according to claim 17, wherein said electrically-controlled projectors include means for controlling the gain of the respective projector to substantially eliminate any residual variations in light-intensity in said overlapping regions.

19. The apparatus according to claim 18, wherein said shadow is multi-colored, and the gain of each of said projectors is electrically controlled for each color.

20. The apparatus according to claim 17, wherein the screen is curved, the projectors are located in front of the screen, and at least some of said shadowing devices are blades having curved obscuring edges producing shadow profiles having center lines coinciding with the center lines of the overlapping regions to thereby reduce light-intensity variations in the overlapping regions caused by the curvature of the screen.
